(19) United States
(12) Patent Application Publication
(10) Pub. No.: US 2006/0025009 A1
(43) Pub. Date: Feb. 2, 2006

(54) Electrical plug

(76) Inventor: Shuming Wu, Nanjing (CN)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/004,405

(22) Filed: Dec. 3, 2004

(30) Foreign Application Priority Data
Jul. 28, 2004 (CN) 200420078132.8

(51) Int. Cl. H01R 13/60

(52) U.S. Cl. 439/528

(57) ABSTRACT

An electrical plug for a power tool is disclosed. The electrical plug comprises a housing having a first end, a second end and a sidewall. The first end of the housing is connected to an electrical cord, and at least one prong protrudes from the second end of the housing. The electrical plug also includes at least one groove formed into the sidewall of the housing. The groove is provided for clasping a portion of said electrical cord.

### CROSS-REFERENCE TO RELATED APPLICATIONS

This application claims the benefit of Chinese Patent Application No. 200420078132.8, filed Jul. 28, 2004 which is incorporated herein by reference.

### FEDERALLY SPONSORED RESEARCH OR DEVELOPMENT

Not Applicable.

### TECHNICAL FIELD

This invention relates to an electrical plug, and more particularly to an improved electrical plug for power tools that is capable of easily binding the linked power cord without any aid of extra belts.

### BACKGROUND OF THE INVENTION

Electrical plugs are well known in the art as they are widely used to power electrical equipment and some electrical tools. For convenient use, the power cord is usually somewhat long. Accordingly, when not in use, the power cord may be bound to avoid entanglement or intertwining. Conventionally, and as shown in FIG. 1, one or more belts or ties are used to bind the power cord. While this method of binding the cords has met with some degree of success, there still exist limitations inherent to such belts or ties.

The present invention is provided to solve the problems discussed above and other problems, and to provide advantages and aspects not previously provided. A full discussion of the features and advantages of the present invention is deferred to the following detailed description, which proceeds with reference to the accompanying drawings.

### SUMMARY OF THE INVENTION

An electrical plug for a power tool is provided. The electrical plug comprises a housing having a first end, a second end and a sidewall. The first end of the housing is connected to an electrical cord, and at least one prong protrudes from the second end of the housing. The electrical plug also includes at least one groove formed into the sidewall of the housing. The groove is provided for clasping a portion of said electrical cord.

According to one aspect of the present invention, at least one groove has a passage with a width less than the diameter of said groove.

According to another aspect of the present invention, the sidewall of the housing is contoured, the contour being provided to cradle the electrical cord when the portion of the electrical cord is clasped in the in the groove.

According to yet another aspect of the present invention, the groove is formed at an angle relative to the plane of the housing.

Other features and advantages of the invention will be apparent from the following specification taken in conjunction with the following drawings.

### BRIEF DESCRIPTION OF THE DRAWINGS

A better understanding of the present invention can be obtained by considering the following detailed description and the accompanying drawings in which:

FIG. 1 is a perspective view showing an electrical cord bound with a belt or tie according the prior art;

FIG. 2 is a perspective view of the preferred embodiment of the plug of the present invention;

FIG. 3 is a bottom view of the plug viewed along the direction A of FIG. 1, illustrating the structure of the notches;

FIG. 4 is a perspective view of one practical use of the preferred plug of FIG. 2;

FIG. 5 is a perspective view of another practical use of the preferred plug of FIG. 2.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

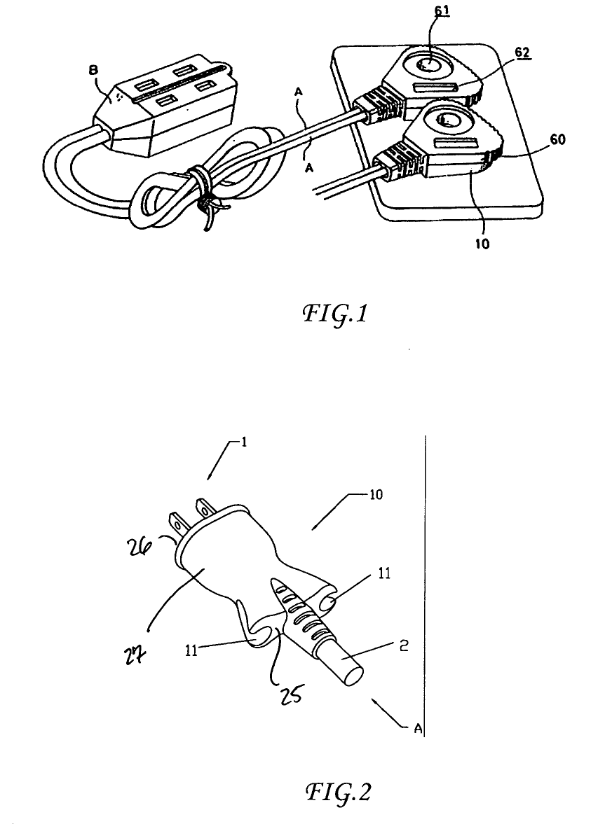

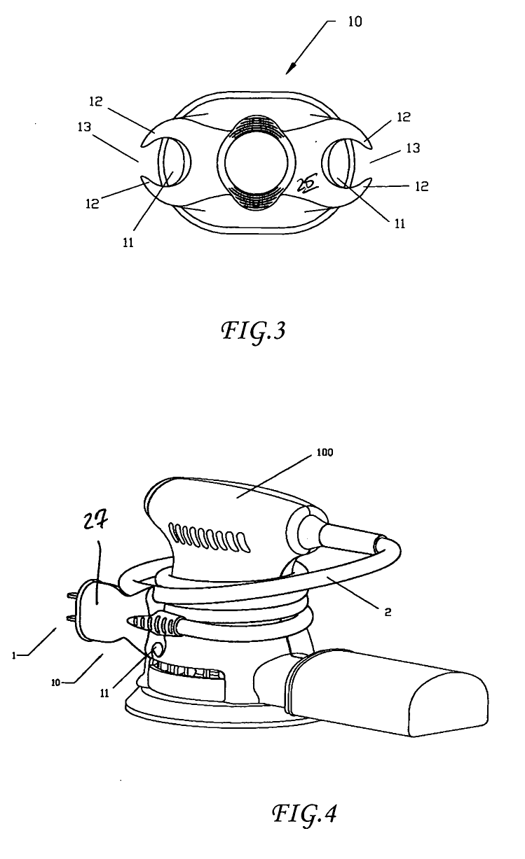

Referring now in more detailed to the drawings, a plug embodying the invention is illustrated in FIG. 2. The plug is comprised of a housing 10 and a prong portion 1 protruding therefrom for electrically connecting to an electrical outlet, wherein the housing 10 includes grooves 11 formed therein. Specifically, the plug has a first end 25, a second end 26 and a sidewall 27. The first end 25 of the housing is connected to an electrical cord, and at least one prong protrudes from the second end 26 of the housing.

Each groove 11 has a cylindrical shape as shown in FIGS. 2 and 3. Persons skilled in the art will recognize that the grooves 11 may have any suitable cross-sectional shapes, including for example, elliptical, rectangular, triangular, or any other shapes that mating suitable for, and corresponding to, the shapes of the cords 2 linked therewith without departing from the present invention. Each groove 11 is preferably of a size that allows the electrical cord 2 to be exactly received therein.

As shown in FIG. 3, each of the grooves 11 is formed by a pairs of arched flanges 12, which extend oppositely from the sidewall 27 at an angle to the housing to form a passage 13 with a width less than the diameter of the groove 11. The power cord 2 generally has an elastic outer layer such that it can be wedged through the passage 13 and be clasped in the groove 11. It is contemplated, that the electrical plug of the present invention may also have only one groove 11 or more than two as suitably required.

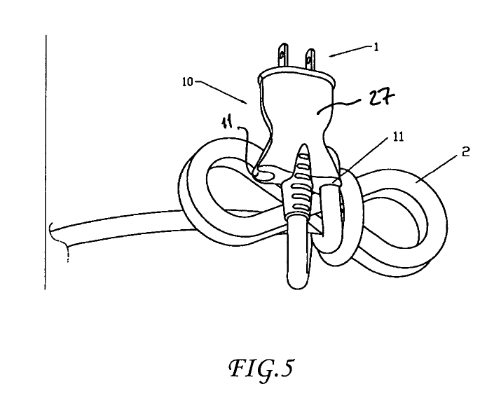

With such a structure, if necessary, users can easily bind the electrical cord 2. For example, referring to FIG. 4, the cord 2 can be wrapped about the body 100 of a power tool or some other electrical device, and then be clasped within a groove 11. Otherwise, the cord 2 can be wrapped about itself and be fixedly clasped by a groove 11 as shown in FIG. 5.

According to one embodiment of the present invention, the sidewall 27 of the plug housing 11 is contoured. As shown in FIG. 4, this contour provides a cradle for the electrical cord when the portion of the electrical cord is clasped in the in the groove.

It thus is seen that an electrical plug is now provided with improved means for holding the linked power cord. Although the invention has been shown and described in its preferred form, it should be understood that many modifications and changes may be made thereunto, without departing from the spirit and scope of the invention.

While the specific embodiments have been illustrated and described, numerous modifications come to mind without significantly departing from the spirit of the invention, and the scope of protection is only limited by the scope of the accompanying Claims.

What is claimed is:

1. An electrical plug comprising:
a housing having a first end, a second end and a sidewall, the first end of the housing being connected to an electrical cord, and at least one prong protruding from the second end of said housing;
at least one groove formed into on sidewall of said housing, the groove being provided for clasping a portion of said electrical cord.

2. The electrical plug of claim 1, wherein each of said at least one groove has a passage with a width less than the diameter of said groove.

3. The electrical plug of claim 1, wherein the sidewall of the housing is contoured, the contour being provided to cradle the electrical cord when the portion of the electrical cord is clasped in the in the groove.

4. The electrical plug of claim 1, wherein the at least one groove is formed at an angle relative to the plane of the housing.

5. An electrical plug comprising:
a housing having a first end, a second end and a sidewall, the first end of the housing being connected to an electrical cord, and at least one prong protruding from second end of said housing; and,
a first groove and a second groove, the first and second grooves being formed into opposed sides of the sidewall of the housing, and each groove being provided for clasping a respective portion of said electrical cord.

6. The electrical plug of claim 5, wherein each of the first and second grooves has a passage with a width less than the diameter of the grooves.

7. The electrical plug of claim 5, wherein the sidewall of the housing is contoured, the contour being provided to cradle the electrical cord when the portion of the electrical cord is clasped in the in the groove.

8. The electrical plug of claim 5, wherein at least one of the first and second grooves is formed at an angle relative to the plane of the housing.

9. A power tool comprising:
a power tool body; and,
an electrical cord being coupled to the power tool body at a first end and being coupled to an electrical plug at an opposed second end, the electrical plug comprising a housing having at least one groove formed therein, the at least one groove being provided for clasping a respective portion of said electrical cord.

10. The power tool of claim 9, wherein each of said at least one groove has a passage with a width less than the diameter of said groove.

11. The power tool of claim 9, wherein the sidewall of the housing is contoured, the contour being provided to cradle the electrical cord when the portion of the electrical cord is clasped in the in the groove.

12. The power tool of claim 9, wherein the at least one groove is formed at an angle relative to the plane of the housing.

13. The power tool of claim 9, the a electrical plug housing comprising:
a first end, a second end and a sidewall, the first end being connected to an electrical cord, and the second end having at least one prong protruding therefrom; and,
a first groove and a second groove, the first and second grooves being formed into opposed sides of the sidewall, and each groove being provided for clasping a respective portion of said electrical cord.

14. The power tool of claim 13, wherein each of the first and second grooves has a passage with a width less than the diameter of said groove.

15. The power tool of claim 13, wherein the sidewall of the housing is contoured, the contour being provided to cradle the electrical cord when the portion of the electrical cord is clasped in the in the groove.

16. The power tool of claim 13, wherein at least one of the first and second grooves is formed at an angle relative to the plane of the housing.
